(19) United States
(12) Patent Application Publication
(10) Pub. No.: US 2005/0108919 A1
(43) Pub. Date: May 26, 2005

(54) Self casting remote control fishing rod

(76) Inventors: Donald Staelens, Waldron, MI (US); Marjorie Staelens, Waldron, MI (US)

Correspondence Address: Simon, Galasso & Frantz, PLC, PO Box 26503, Austin, TX, 78755-0503, US

(21) Appl. No.: 10/993,788

(22) Filed: Nov. 20, 2004

Related U.S. Application Data
(60) Provisional application No. 60/523,917, filed on Nov. 21, 2003.

(51) Int. Cl. A01K 91/02

(52) U.S. Cl. 43/19; 43/21

(57) ABSTRACT

This product is designed to provide a means by which those with limited physical strength can enjoy fishing. The device promotes the casting and retrieving of a fishing line through the use of a self-casting mechanism. The Self-Casting Remote Control Fishing Rod comprises a rod, reel, wire line, cast button, bail button, bobber, bobber bell, handle, gas source, and may also include a safety trigger, radio receiver, bail, solenoid, rewind button, self-caster mechanism, solenoid valve, compression chamber, electric motor, gear driven reel, power source compartment, and radio activated transmitter/receiver unit.

### CROSS REFERENCE TO RELATED APPLICATIONS

This Non-Provisional patent application claims priority to U.S. Provisional Application Ser. No. 60/523,917 filed on Nov. 21, 2003 entitled “Self Casting Remote Control Fishing Rod.”

### FIELD OF THE DISCLOSURE

The disclosures made herein relate generally to a self-casting remote control fishing rod. The invention discussed herein is in the general classification of fishing equipment.

### BACKGROUND

Fishing is a popular activity enjoyed by millions of people worldwide. Fishing is also one of the largest food-acquiring industries in the world.

The typical fishing rod often consists of simply a hook, a line and a sinker. However, the skilled, experienced angler will often have a variety of fishing rods, reels, line types, hooks, floats and artificial lures secured in a portable container for protection and ease of access.

Unfortunately, those who enjoy fishing and are physically disabled are restricted in their ability to cast a line into the water. For example, physical weaknesses caused by arthritis can prevent a person from being able to push the line release button on the reel with sufficient pressure to allow it to operate properly. Other factors, such as age, disease, and physical injuries can limit one's ability to retrieve the line as well. Without special accommodations, a physically limited person would be unable to participate in fishing outings.

### SUMMARY OF THE DISCLOSURE

The Self Casting Remote Control Fishing Rod operates through the use of electronic components in conjunction with standard fishing rod and reel components. Generally, it comprises a rod, reel, wire line, cast button, radio receiver, bail and/or bail button, solenoid, bobber, rewind button, solenoid valve, compression chamber, electric motor, gas source, power source, and radio activated transmitter/receiver unit.

In some embodiments of the invention, by pressing the cast button, a radio receiver unit is activated. This causes a solenoid to open the bail on the fishing rod and reel. The solenoid then retracts, causing a carbon dioxide bobber projector or shooter to discharge. Another button component engages the rewind reel. Both of these buttons are easily accessible on the handle of the device or through the use of a remote control device.

In another embodiment of the invention, by pressing the cast button, a gas source stored in the handle of the fishing rod releases gas to flow through a hollow rod and discharge a bobber placed at the end of the rod in a compartment called the bobber bell. The bobber is attached to a wire line and connected to a reel attached to the handle of the fishing pole.

The principal object of this invention is to provide an automatic casting fishing rod.

Another object of this invention is to provide a fishing rod that is relatively cheap and easy to use.

### BRIEF DESCRIPTION OF THE DRAWINGS

FIG. 1 depicts a perspective view of the self-casting remote control fishing rod.

FIG. 2 depicts a perspective view of another embodiment of the self-casting remote control fishing rod.

FIG. 3 depicts a perspective view of yet another embodiment of the self-casting remote control fishing rod.

### DETAILED DESCRIPTION OF THE DRAWINGS

The Self Casting Remote Control Fishing Rod comprises at least some of the following: a rod, reel, wire line, cast button, radio receiver, bail, solenoid, bobber, rewind button, solenoid valve, compression chamber, electric motor, gas source, power source compartment, and radio activated transmitter/receiver unit.

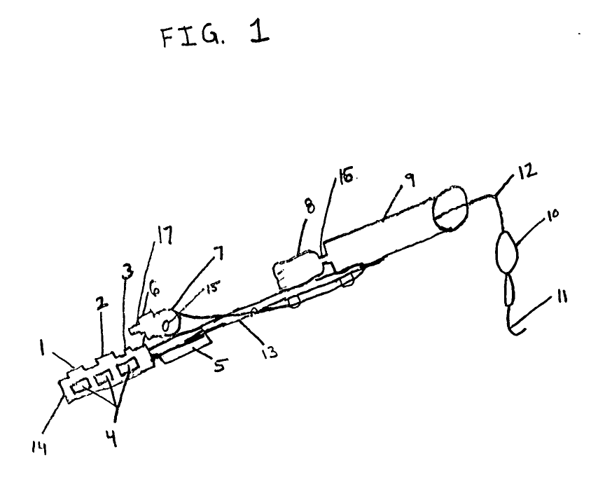

In one embodiment of the invention, shown in FIG. 1, a rod 13 has handle 14 attached to it on one end. A cast button 1 and a rewind button 2 are located on the handle 14 for use with casting a line 12 and retracting a line 12 once it is cast. A power source compartment 4 is also located in the handle 14. Typically, a battery is inserted into the power source compartment 4, although other power sources can also be employed.

Adjacent to the handle 14 is an electric motor 15 that is powered from the battery or other power source located in the power source compartment 4. There is also a gas pressure chamber 9 connected to the rod 13 at the opposite end as the handle 14. The gas pressure chamber 9 is connected to a gas source 8 via a tube 15 to allow discharge of a bobber 10 attached to the line 12 and placed within the gas pressure chamber 9. Most often a CO₂ container is attached to the gas pressure chamber 9 though other types of gases can also be used. At the end of the line 12, a hook 11 is attached. A reel 7 is also connected to the electric motor 15 and contains the line 12. A solenoid 6 is located next to the reel 7 and connected to a bail 17. The rod 13 also has a radio receiver unit 5 located on the rod 13 and activated by the cast button 1 and rewind button 2.

The radio receiver unit 5 can also be activated by a remote control unit with a cast button and rewind button located on the remote control unit.

By pressing the cast button 1, the radio receiver 5 is activated. This causes the solenoid 6 to open the bail 17 on the rod 13 and reel 7. The solenoid 6 then retracts, causing the bobber 10 to discharge. The rewind button 2 engages the reel 7 to allow retraction of the line 12 and bobber 10. A safety button 3 can also be included on the handle 14 to prevent accidental discharge of the bobber 10.

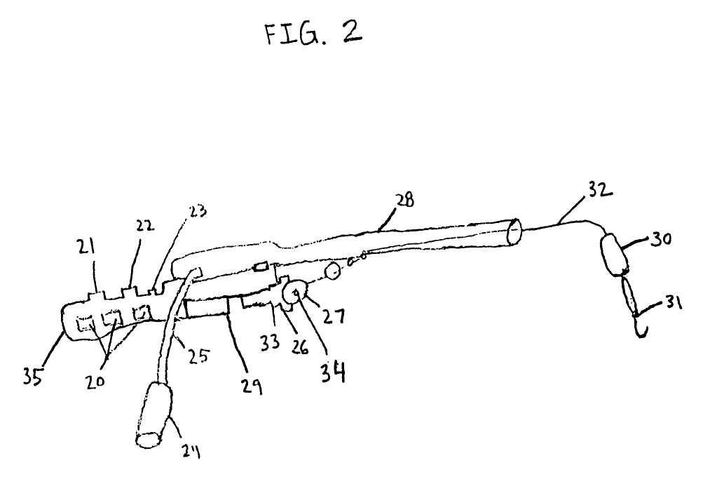

In another embodiment of the invention, as shown in FIG. 2, no rod is utilized. Instead, the gas pressure chamber 28 is directly connected to the handle 35. A cast button 21 and a rewind button 22 are located on the handle 35 for use with casting a line 32 and retracting a line 32 once it is cast. A power source compartment 20 is also located in the handle 35. Typically, a battery is inserted into the power source compartment 20 though other power sources can also be employed.

Adjacent to the handle 35 is an electric motor 34 that is powered from the battery or other power source located in the power source compartment 20. The gas pressure chamber 28 is connected to a gas source 24 via a tube 25 to allow discharge of a bobber 30 attached to the line 32 and placed within the gas pressure chamber 28. Most often a CO₂ container is attached to the gas pressure chamber 28 though other types of gases can also be used. At the end of the line 32 a hook 31 is attached. A reel 27 is also connected to the electric motor 34 and contains the line 32. A solenoid 26 is located next to the reel 27 and connected to a bail 33. A radio receiver unit 29 is connected to the handle 35 and activated by the cast button 21 and rewind button 22. A safety button 23 can also be included on the handle 35 to prevent accidental discharge of the bobber 30. This embodiment works in much the same way as that discussed in connection with the embodiment shown in FIG. 1.

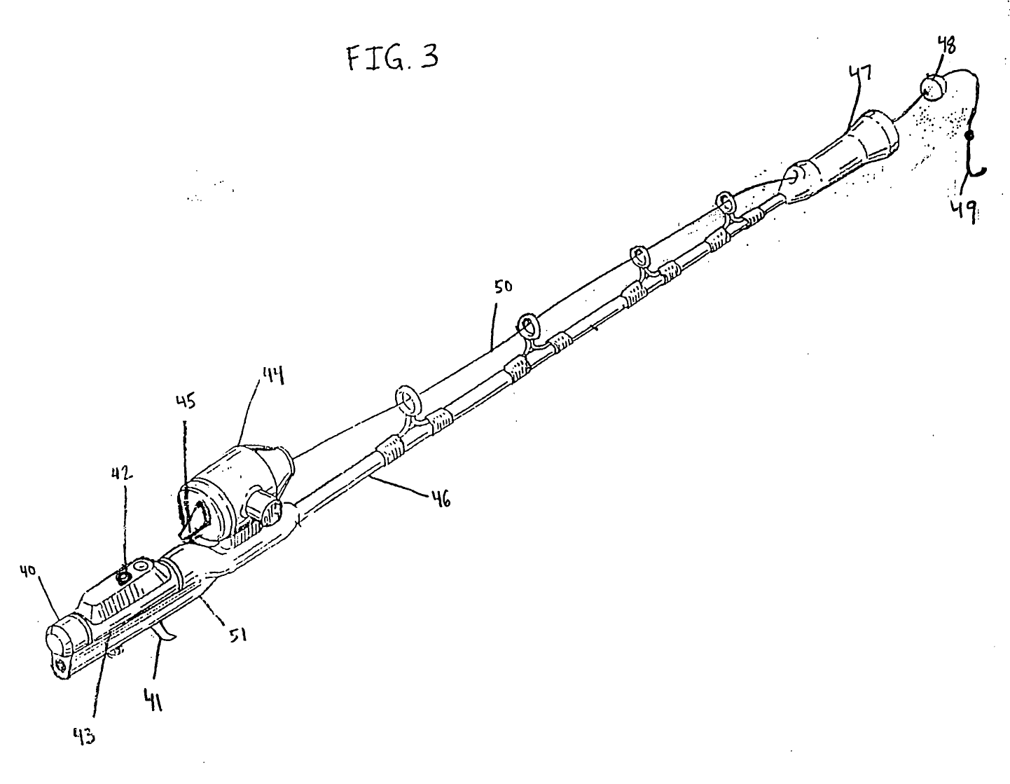

In the preferred embodiment of the invention shown in FIG. 3, a handle 51 is connected to the rod 46 and a gas source container 43 is inserted into the handle 51 through a cap 40 located on one end of the handle 51. A cast button 42 is located on the handle. A reel 44 is located either on the handle 51 or the rod 46 and has a bail button 45 located on the back of the reel 44. A safety trigger 41 can also be located on the handle 51 to prevent the gas source container 43 from allowing gas to flow through the rod 46 when the cast button 42 is pressed.

A bobber bell 47 is attached on the opposite end of the rod 46. A bobber 48 can be placed inside the bobber bell 47. The bobber 48 is connected via a wire line 50 to the reel 44. A hook 49 is also located on the end of the wire line 50 that runs through the bobber 48.

In the embodiment disclosed in FIG. 3, pressing the bail button 45 activates the reel 44 and allows the wire line 50 to be dispensed. After the bail button 45 is pressed, the cast button 42 is pressed which releases the gas from the gas source container 43 located inside the handle 51. The gas flows through the rod 46 to the bobber bell 47 and discharges the bobber 48. As the bobber 48 discharges from the bobber bell 47, the wire line 50 begins to dispense from the reel 44. When the wire line 50 has dispensed to the distance desired by the operator, the bail button 45 is pressed again locking the reel 44 and preventing any more wire line 50 from being dispensed. In this embodiment a safety trigger 41 can be placed on the handle 51 and prevent accidental discharge of the bobber 48 when the cast button 42 is pressed.

Many of the embodiments of this invention have the form of a standard fishing rod and reel. As such, the invention varies in length and component configuration. Some models are as short as four feet in length while other models are as long as nine feet. The weight of the rod usually will range from two to nine pounds. Of course, any length or weight of rod is acceptable for the present invention.

Self-Casting Remote Control Fishing Rod is constructed of the best quality materials commonly accepted and used in the manufacturing industry today. The metals would ideally be selected from available steel or alloys of steel and aluminum. The production process related to the use of these metals insures that the metal is non-corrosive, durable and strong. The selected metal should have high impact strength and be capable of accepting and retaining coloring materials for an extended length of time.

Plastic will also be used in the production process of the Self-Casting Remote Control Fishing Rod. The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

All electronic components of the invention will be selected from those currently having the highest industry ratings. These components will also meet and/or exceed all safety and usage regulations. Wiring and associated connecting hardware should be insulated and otherwise protected from intrusion by any harmful or degrading elements, including water, medium level temperatures, and low to medium impact force.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

1. A fishing device comprising:
(a) a rod;
(b) a handle attached to one end of the rod;
(c) a cast button located on the handle;
(d) a rewind button located on the handle;
(e) a power source located inside the handle;
(f) an electric motor located adjacent to the handle;
(g) a gas pressure chamber connected to the rod at the end opposite the handle;
(h) a gas source connected to the gas pressure chamber via a tube with one end of the tube connected to the gas source and one end to the gas pressure chamber;
(i) a bobber attached to a wire and located inside the gas pressure chamber;
(j) a hook attached to an end of the wire;
(k) a reel connected to the electric motor and containing the wire;
(l) a solenoid located next to the reel;
(m) a bail connected to the solenoid; and
(n) a radio receiver unit located on the rod and activated by the cast and rewind button.

2. The fishing device of claim 1 further comprising:
a safety switch located on the handle.

3. The fishing device of claim 1 further comprising:
a remote control with a cast button, a rewind button and a power source.

4. The fishing device of claim 1 wherein the gas source is CO₂.

5. The fishing device of claim 1 wherein the power source is a battery.

6. A fishing device comprising:
(a) a handle attached to one end of a gas pressure chamber;
(b) a cast button located on the handle;
(c) a rewind button located on the handle;
(d) a power source located inside the handle;
(e) an electric motor located adjacent to the handle;
(f) a gas source connected to the gas pressure chamber via a tube with one end of the tube connected to the gas source and one end to the gas pressure chamber;
(g) a bobber attached to a wire and located inside the gas pressure chamber;
(h) a hook attached to an end of the wire;
(i) a reel connected to the electric motor and containing the wire;
(j) a solenoid located next to the reel;
(k) a bail connected to the solenoid and having a valve; and
(l) a radio receiver unit located adjacent to the handle and activated by the cast button and rewind button.

7. A fishing device comprising:
(a) a handle;
(b) a gas source container connected to the handle;
(c) a cast button located on the handle;
(d) a rod connected to the handle; and
(e) a reel connected to the handle and having a bail button.

8. The fishing device of claim 7 further comprising:
a bobber bell located on the rod opposite the handle.

9. The fishing device of claim 8 further comprising a bobber connected to a wire line placed in the reel.

10. The fishing device of claim 7 wherein the gas source is located within the handle.

11. The fishing device of claim 10 wherein a cap is located on the handle covering an opening for the gas source container to be inserted into the handle.

12. The fishing device of claim 7 wherein a safety trigger is located on the handle.
